(19) United States
(12) Patent Application Publication
(10) Pub. No.: US 2003/0102675 A1
(43) Pub. Date: Jun. 5, 2003

(54) Power generators and method and device for generating power

(75) Inventor: Leo Noethlichs, Geilenkirchen (DE)

Correspondence Address: HENRY M FEIEREISEN, 350 FIFTH AVENUE, SUITE 3220, NEW YORK, NY, 10118, US

(73) Assignee: UMWELTKONTOR RENEWABLE ENERGY AG, Erkelenz (DE)

(21) Appl. No.: 10/273,751

(22) Filed: Oct. 17, 2002

Related U.S. Application Data
(63) Continuation of application No. PCT/DE01/01473, filed on Apr. 17, 2001.

(30) Foreign Application Priority Data
Apr. 17, 2000 (DE) 100 19 200.9
Apr. 28, 2000 (DE) 100 20 965.3

(51) Int. Cl. F03D 9/00; H02P 9/04

(52) U.S. Cl. 290/44

(57) ABSTRACT

In order to coordinate power generators and consumers in a power grid using intelligent management, a method for generating power is provided wherein at least two decentralized power generators are connected to an electric power grid. A value for the current output of at least one power generator is measured and compared to a nominal output. The output of the power generators connected to the electric power grid is adapted according to the result of the comparison.

### CROSS-REFERENCES TO RELATED APPLICATIONS

This application is a continuation of prior filed copending PCT International application no. PCT/DE01/01473, filed Apr. 17, 2001, which was not published in English and which designated the United States and on which priority is claimed under 35 U.S.C. §120, the disclosure of which is hereby incorporated by reference.

This application claims the benefit of prior filed provisional application, Appl. No. 60/206,277, filed May 23, 2000, pursuant to 35 U.S.C. 119(e), the disclosure of which is incorporated herein by reference.

This application claims the priority of German Patent Applications, Serial Nos. 100 19 200.9, filed Apr. 17, 2000, 100 20 965.3, filed Apr. 28, 2000, and 100 24 249.9, filed May 17, 2000, pursuant to 35 U.S.C. 119(a)-(d), the disclosure of which is incorporated herein by reference.

### BACKGROUND OF THE INVENTION

The present invention relates to a method and a device for generating power, wherein at least two decentralized power generators are connected with a power grid and feed power into the power grid.

The benefit of power generation from renewable power sources is generally unpredictable, since only the actually saved fuel costs can be considered as savings compared to conventional power plants.

When the share of renewable power in a power grid exceeds about 30% of the total power supply, technical solutions for stabilizing and maintaining a high quality in the power grid are required.

So far, the regional autonomy as well as the efficiency of the existing power producers has enabled blocks of a power plants to be connected to or disconnected from a power grid according to the expected to load. Small power producers simply supplied power to the grid. Variations are compensated by having the large power plants supply more power. This results in a very rudimentary load management which only includes adding or removing power over time or based on telephone instructions from the power plant operators.

It would therefore be desirable and advantageous to provide an improved method to coordinate power generators and power consumers in a national power grid through an intelligent management system.

### SUMMARY OF THE INVENTION

According to one aspect of the present invention, in a method for power generation, at least two decentralized power converters are connected with a power grid, wherein power-converter-specific parameters are determined and calculated for at least one power converters, in particular different power converters. The respective power-converter-specific parameters are transmitted via a standardized interface to a global data network, wherein the corresponding power-converter-specific parameters are combined in a standardized interface. In this way, the corresponding power-converter-specific parameters are accumulated by a central data server and converted to an actual instruction for a power generator in the global data network. The respective actual instruction is then transmitted via the standardized interface from the global data network to a corresponding power converter. The operating parameters of the corresponding power converter are readjusted by taking into account the actual instruction.

The term power converter applies hereby to power generators as well as power consumers. This relates both to industrial power converters as well as private power converters. For example, a power generator can be a coal-fired power plant, which supplies an entire region with power, but can also be a windmill, which can primarily provide power for agricultural use and feeds only surplus power to a national power grid. Power consumers can also have various forms. For example, a steel plant having an extremely high power consumption, and a washing machine of a private customer can be part of the method of the invention for generating power. The term power converter is also meant to include energy storage facilities, such as pumping installations whereby water is pumped into a reservoir and used as needed for power generation, as well as a hydrogen storage facility.

The almost unlimited number of different energy converters, in particular also of power generating plants, has so far made a global or national intelligent and automatic network environment practically impossible. This is caused in particular by the different types of energy converters, for example a wind mill, a solar energy installation, a biogas plant or a coal- or gas-fired power plant, or a steam plant. In particular, power generators relying on renewable energy are particular dependent on environmental conditions. This is the another reason why until now such power producers were difficult to integrate with primary power sources in a power grid. It is also difficult to integrate decentralized power converters because different plant manufacturers typically specify different operating parameters for their plants. The different regional rules and laws and other regulations for the plant standards poses also a problem, in particular for a power grid spanning several countries. Only if power-converter-specific parameters of the various power converters are coordinated can a global or national power grid be reasonably operated.

According to the invention, a standardized interface which adapts power-converter-specific parameters so that they can be compared, forms the basis for cooperation of different power converters in a power grid. The interface enters the grid preferably with a profile which includes as specification the actual capacity or a quantity proportional to the actual power generating capacity, as well as an entry about possible additional information, such as the type of the power converter, potential capacity (or a quantity proportional thereto), possible additional interventions, maintenance times and the like. The profile received by the interface includes as instructions preferably a nominal power or capacity or a percentage of the maximum possible capacity or quantity proportional thereto. These can then be converted by the interface into power-converter-specific parameters, such as gate settings on a water mill, turbine blade settings of windmills and the like.

It is advantageous to provide a global network for realizing the invention, which is based for example, on the Internet, wherein the global data network, for example a network in parallel with the power grid, combines the data of the individual power converters, preferably all relevant process-oriented components, in such a way that the data are accumulated and processed, for example, by a central data server. The central data server can be integrated with the global data network. However, the power grid itself, to which the energy converters are connected, can also be used as the global data network.

The central data server receives preferably power-converter-specific parameters from all power converters, wherein these parameters can be processed by the central data server both as raw data as well as processed data. The central data server thereby acquires and processes the actual operating conditions of a global power grid, and provides instructions to the individual power converters, whereby the corresponding power converters use the actual instructions to adjust the operating parameters to a new power grid situation.

The central data server does not necessarily have to be a single computer, and several data server connected to each other can be used. Servers can also be operated in parallel to provide redundancy for a more reliable operation. The tasks can also be specified, for example, according to energy providers, countries (national independence of the power supply), power grids and/or tasks (power producer-power consumer). Hierarchical structures can also be established, whereby certain central tasks are processed country-specific, whereas on site the power is optimized locally to minimize the length of the power lines transmitting the power. Preferably, the local servers are implemented autonomously to be able to react to a server malfunction of a master server or a peer server, in which case they can switch, for example, to maximum power by sending the message to an accessible, preferably hierarchically higher server.

It will be understood that the method of the invention is suitable in particular for the aforedescribed power generators. However, power consumers, power storage facilities, as well as preferably all components of a local, regional or global power grid participating in the process can also be addressed.

For example, the nominal power of a regional or global power grid to can be automatically adjusted with the method of the invention for power generation.

If the nominal power of a power grid is not reached, then an additional power generator can be automatically connected to the power grid, with the added power generator increasing the power in the power grid to the desired nominal power. The nominal power is represents mainly of the power withdrawn from the power grid by the power consumers.

It is also possible that a power generator which is integrated into power grid, automatically increases the power production and thereby feeds correspondingly more power to the power grid. This process is also fully automated.

If the power of the added power generator is insufficient to reach and/or maintain the nominal power, then additional power generators are added to the power grid.

It is also possible to switch, preferably temporarily, energy storage devices into a power grid to compensate for any peaks in consumption and maintaining a nominal power level.

The method according to the invention allows an intelligently coordination of independently operating power generators, without relying on external manual instructions from one or several switching stations to provide the required power.

Using this method, power generators can be quickly and effectively switched in or switched out, and their power can be regulated. Independent of other characteristics of the present invention, such power regulation is advantageous also for power generators of regenerative power, such as solar, wind or hydroelectric power, which until now have operated with maximum power to guarantee their ability to supply power and to get paid. For example, hydroelectric power could be applied calculatedly and as needed. By operating with maximum power, maintenance times may be significantly extended and wear reduced. On the other hand, maximum loads and/or power reserves of the individual power producers could also be used on purpose. For example, a windmill could be operated under steady, but strong wind conditions for short time in overload. In particular, time- and/or power-dependent components of the power converters could be operated so as to have a longer lifetime and be more costeffectively. In addition, maintenance service could be performed at reduced power levels and the corresponding serviced installation could still be used to provide peak loads by briefly interrupting such maintenance and operating the installation at a higher load.

To promote an optimal cooperation between the power generators linked by the power grid, the producible power of at least one power generator is advantageously taken into account when matching power requirements. In other words, the instantaneous possible power of the individual power generators should be taken into account and coordinated for harmonizing the power. For example, the actual wind situation of a wind power plant should be continuously determined and recorded. In this way, it can be determined at any point in time by how much the instantaneous effectively supplied power can be increased, which is particularly advantageous when operating at reduced power. In addition, peak loads can be coordinated by operating a plant at least for a short time at a maximum power rating. A wind power plant can react differently under gusty wind conditions than under constant wind speed.

By continuously determining and processing weather data, the wind conditions to be expected around the wind power plant can be forecasted with sufficient accuracy and the producible power be estimated. This estimate is then taken into account when harmonizing the power requirements.

By determining the producible power, which can vary by the sunshine duration, variations in the wind speed or other external conditions, the actual adaptation can be made.

According to a preferred embodiment of the method of the invention, the actual state of at least one power generator can be monitored. For this purpose, the power data of the individual power generators are automatically accumulated, thereby providing continuous information about the actually available power in the power grid. By continuously monitoring and recording the actual state of an energy generator, a certain limited power profile can be produced. In this way, recurring power variations can be forecast and reacted to. Information about the efficiency, downtime and maintenance times can be derived from the information of the actual state of a power generator.

Preferably, the expected or producible power of at least one power generator can be forecasted. By determining the producible power, which is influenced, for example, with renewable energy sources by the sunshine duration, variations in the wind speed or other external conditions, adjustments can be readily made.

By forecasting the expected power requirements, even if this forecast is relatively imprecise, valuable time can be gained to better and/or more timely react to power variations by adding additional power generators, by buying power and/more by adding energy storage facilities.

For example, the expected wind speed can be forecasted for a wind power installation by taking into account, for example, data from public or private weather forecasting organizations. Alternatively, special weather research organizations can be tapped as additional sources of information.

Advantageously, for forecasting the expected wind conditions, the own network of the individual network power generators can be used in addition or exclusively. The distributed power generators can collect the required weather data and use these weather data for a weather forecast.

According to another aspect of the present invention a device for power generation includes at least two decentralized energy converters, in particular two mutually independent energy converters, connected to a national or global power grid, wherein the power converters have at least one standardized interface connecting the power converters to the global or national data network. The device according to the invention, in particular the device with the standardized interface, allows the power converter of a global or national power grid to connect all relevant process-oriented components of the power grid in such a way that preferably all power converters communicate with each other either directly or indirectly, making it possible to adjust the operating parameters of the individual power converters to the conditions in the power grid.

Advantageously, the control is handled by a central data server connected to the data network. All power-converter-specific parameters are combined in the central data server for processing in the central data server. The power-converter-specific parameters are, for example, processed by the individual power converters and/or by the interfaces, which substantially reduces the data flow associated with the power-converter-specific parameters in the global data network. For example, it may be sufficient to indicate the provided power or the producible power.

The device according to the invention for power generation is particularly suited for power management, wherein preferably the parameters of the power generators relating to the offered heat or power are acquired and matched with the demand of the industrial and private consumers.

Advantageously, means for measuring the power can automatically measure the actual power of the decentralized power generators, which allows continuous updating of the power data. This ensures a simple and rapid as well as uninterrupted measurement of the power preferably of all power generators connected to the power grid. Advantageously, the device for power generation includes means for comparing the measured nominal power data. The means for measuring the power and the means for comparing the measured data are arranged so that a comparison of the power data with the nominal power is always automatic, thereby automatically compensating unwanted variations in the supplied power or an overrun or underrun of the nominal power. Advantageously, means for matching the power supplied to the power grid according to the comparison result are provided. The automatic adaptation of the supplied power advantageously prevents long delays and eliminates cumbersome telephone instructions to the operator of a power plant.

Advantageously, the power compensation or power adaptation is very smooth, since changes in the power grid are immediately detected and possible variations in the power grid are also immediately compensated by the aforedescribed automatic method.

According to another feature of the present invention, the device may have as a buffer at least one energy storage facility that is connected with the power grid and/or with at least one energy generator. The energy storage facility can compensate peak loads in power consumption or in power supply similar to a capacitor. If such peak loads occur, for example, in power consumption which cannot be compensated or can only be inadequately compensated by power generators connected to the grid, then the power is provided by an energy storage facility.

If a power generator offers power at low cost, for example making excess power available from a wind power plant due to strong wind conditions, then the energy storage facility can be automatically replenished. The energy storage facility can be directly associated with the power generator. If such associated energy storage facility is not available, then the power can be supplied to an arbitrary energy storage facility.

Advantageously, power can be purchased inexpensively in the event of an oversupply and stored in the energy storage facility, with the stored energy being sold by an operating company to the highest bidder in the event of a power deficit, if the power deficit is not compensated immediately by other power generators. By this intelligent control and/or by an intelligent implementation of such energy storage facilities, an operating company of such energy storage facilities can derive additional economic gains.

Such energy storage facility can be provided locally, for example in the form of an energy park, or decentralized at a suitable location, for example in the form of a reservoir. When arranged locally, only short transmission lines are required for peak loads. Alternatively, a local hydrogen storage facility can be established for fueling vehicles and the like, whereby preferably initially a local energy storage facility is filled, with excess energy subsequently supplied to a national storage facility. This arrangement minimizes transport distances.

Advantageously, means for determining the producible power of at least one power generator connected to the power grid are provided. For example, these means indicate to a hydroelectric power plant that the water reservoir is full and at full capacity. Alternatively, the means can be used to measure of the wind speed at a wind power plant and to calculate with these values, by taking into account the instantaneous produced power, how much additional power could be produced at that particular time.

The expected power reserves of each power generator can be determined relatively accurately. In particular, power generators which are very dependent of external conditions, can be coordinated effectively and easily. In this way, the power producers of renewable energy which strongly depend of environmental conditions, can be directly coordinated and coordinated by, for example, compensating for power variations, so that the power generators can be utilized with the highest efficiency.

This also makes it possible to calculate the present unpredictability of conventional installations which are dependent on external environmental conditions, so that utilizing renewable energy appears in an entirely new light. Power generators operating with renewable energy sources can then operate with much improved efficiency.

In another embodiment, means for monitoring an actual state of a power generator are provided. For example, means are arranged on a wind power plant which record audio and/or video data and thereby document the actual operating state of the wind power plant. Running noise can hereby alert maintenance personnel of a required maintenance or possibly damage to the wind power plant. Alternatively, the actual blade noise can be compared with an optimal noise profile. The blade position can be optimized by comparing these results.

Advantageously, the instantaneous power can be determined by providing the power generator with a power meter or another device for measuring to the power. For example, an electronic power measuring device can measure the energy flow and transmit the operating state to the data server administering the corresponding data sets.

Arranging means for forecasting the expected power and/or the producible power of at least one power generator, for example by using anemometers, weather stations, exposure meters and the like, makes it possible to optimize utilization of individual power generators. Providing a forecast in decentralized form on site can reduce the computing load of a central computer, for example a central data server.

For example, a specific field profile can be generated for each power generator by matching the weather data with the utilization of the different power generators, allowing a faster reaction to power variations in the power grid.

Continuously determined weather data can be used to forecast which power generator should preferably be used for generating power at which point in time. It can be determined ahead of time based on the weather forecast which and how much power resources will be needed at a particular point in time, so that the power availability of the entire power grid can be calculated and effectively implemented. This calculability is particularly important for power generators relying on renewable energy sources, because there is no other way for ensuring an efficiency level close to the nominal efficiency of the power grid.

Preferably, means are provided that automatically integrate a data measuring station and/or an interface to a power converter into a corresponding network (Plug-and-Play). Data measuring stations are to be understood as including all data measuring means existing with the power generator or power consumer. It is a hereby unimportant if the automatic integration is on the supply side and/or consumer side of the power grid. Automatic integration can be guaranteed by, for example, providing an automatic connection with the network by simply connecting a data measuring device—for example, by connecting a data measuring device that communicated via the power grid to the power grid. Preferably, a corresponding registration routine is implemented.

Advantageously, the device can include a preferably publicly accessible output device for outputting an information data set with information about the state of the power generator and/or the power grid, including means for checking the authorization of a reader of the output device for receiving this information. This output unit provides information to everyone authorized at a corresponding authorization level. These can be, for example, customers, owners of individual power generators, power grid operators and the like. For example, owners or co-owners of individual power generators can be informed about the actual state of their installations. Images of the installation and/or noise of the running installation can also be transmitted. Information about energy generation, maintenance and downtimes and other information can be requested.

If the output unit is publicly accessible, a person seeking the information can retrieve this information simply and cost effectively.

The term “plant” or “installation” includes all relevant power generating facilities, power consumers, energy storage facilities etc. associated with a power grid.

Preferably, the output means are connected with a power grid, with the communication being provided by the power grid. The output means can also provide additional energy flow data, in particular as a function of time. Specifically identified data are only transmitted to authorized individuals or group of individuals. This can apply, for example, to data that include information about a maintenance status of the power generator or data indicating the current income or loss of an plant. The public can view, for example, images of the plant or general information, such as the rotation speed of the rotor, the wind velocity, the power production. In addition, a panoramic view of the surroundings of the site can be provided.

Advantageously, the output unit includes means for checking the authorization of a reader for receiving this information. For example, the reader can identify himself on a keyboard through a numeric code or a combination of an alphanumeric and numeric code or the like. Alternatively, a special chip cart or simply a credit card can also be used for identification.

According to another aspect of the present invention, an interface of a global or national data network includes means for combining of power-converter-specific parameters of at least one power converter, in particular of mutually different power converters being part of a global or national power grid. Advantageously, all energy converters of a global power grid can have a corresponding interface to the network, so that the power-converter-specific parameters are uniformly measured for all energy converters. The global data network can be a part of the global power grid.

The interface according to the present invention makes it possible to link the power converters, in particular the power generators that strongly depend on environmental conditions, with each other and to thereby increase their efficiency, in particular the efficiency of the power generators relying on renewable energy.

According to still another aspect of the present invention, a profile of an interface is provided which merges power-converter-specific or power-grid-specific parameters. Power-grid-specific parameters include, for example, all parameters that relate to the other process-related components.

Advantageously, the profile filters the power-converter-specific parameters into business-specific data and multimedia-specific data and provides these data to different clients. For example, user-specific data of the global power grid are supplied in the form of efficiency data to an industrial power consumer which is classified here as a business client. The efficiency data can include the currently available power and the power requirements expected for the next several hours. The client can then adjust his power consumption to the actual or projected power data of the power grid.

Business-specific data can be obtained by automatically executing a query implementing a predetermined authorization request.

Multimedia-specific data can also be provided to a private Internet user. These can include general data for a wind power plant including, for example, moving images of the wind power plant or data about the wind velocity and/or rotation speed of the rotor of the wind power plant.

According to still another aspect of the, present invention, a power generator is provided with a preferably automatically readable output unit for the actual power. By outputting the actual power automatically, the power/efficiency data can be automatically updated. For example, a power meter or another device for measuring an amount of energy includes means for electronically outputting the energy flow, thereby automatically determining the actual power. In addition, the device for measuring to the amount of energy can include devices for forecasting power consumption. Such device hence provides forecasts on site in a decentralized fashion, thereby relieving a central computer. The output unit is, for example, connected online to a corresponding data processing unit, whereby the process can implement measures for immediately reacting to variations of a power generator.

Advantageously, the output unit can also indicate the producible power. The output unit transmits data sets which include information of the producible power of a power generator. The data sets include identification so that all authorized persons or an authorized system can access the information contained in the data sets. The producible power is to be understood as the difference between the currently effectively produced power and a fictitious power which the power generator could theoretically produce based on the currently prevailing weather conditions. This information is also continuously and automatically coordinated.

Advantageously, the output unit can also output information of the current status of the power generator, this information is also automatically determined and transmitted to a corresponding processing location. By providing the current status of a power generator information about the expected productivity, downtime or maintenance times can also be provided.

Advantageously, the power generator can include an input unit for automatic power control of the power generator. Depending on the power requirements, the available capacity of the power generator can be reduced or increased, as needed. This enables an interactive control among the power generators, so that the corresponding power generators can be optimally utilized.

Advantageously, a power generator can have a preferably publicly accessible output unit for outputting an information data set with information about the status of the power generator and means for checking the authorization of a reader reading the output unit for obtaining this information. If the output unit is to be publicly accessible, then the information can be easily and cost-effectively requested by the respective individual seeking the information. Special information data sets can be identified so that they can be read only by an authorized group of individuals. For identification, a numeric code can be inputted via a keyboard to give the reader access to the desired data sets. Such information data sets can be exchanged between the power generators or power consumers by implementing the an automatic registration or command routine.

Advantageously, in a first step, the system is tested and evaluated, for example, with wind power plants. Initial improvements can be made. For example, power plants from different manufacturers or operators may have to be adjusted to an automatically operating standard, and data may have to be obtained and processed in a uniform manner. Optionally, computers can be installed in the individual facilities or the communication configuration in the individual wind parks can be reconfigured, with is essential for operating all wind power plants in a power grid efficiently. It will be understood that power generating facilities other than wind power plants can be used with the aforedescribed system.

The energy or power grid is preferably that of a regional power provider. The system is subsequently expanded nationally to other energy providers, finally to all energy providers in Germany and other countries. The system can be employed all over Europe providing that the individual interfaces of the energy providers and/or energy generators are coordinated with each other. The system hereby supports load management of the power grid operators, allowing providers that use renewable energy sources and conventional energy providers to work hand-in-hand.

According to another feature of the present invention, the data server of a local network transmits automatically the data with information to at least one central data server in a wide area network (WAN). It is assumed that the control of the individual wind power plants, in particular if they are manufactured by different manufacturers or operated by different operating companies, is adapted to the automatic system of the wide area network and/or of the central data server, or made compatible by applying suitable filters. For example, certain data are transmitted automatically to a central data server, whereby the data server of the local network is only required for collecting the continuously updated data sets. This has the advantage that the data server can be kept small because it does not have to have the computer power required for processing and/or managing the data sets. The continuously updated available data provide information about the actual operating state of a power generating facility. This ensures a reliable cooperation between several energy generating facilities.

Preferably, the recorded data, in particular with energy parks, wind parks and the like, are transmitted automatically to at least one data server via a local network (local area network-LAN). Preferably, all data acquired by the data acquisition means are transmitted by a local network to a data server, where they can be temporarily stored. In this way, several data sets with information about the current operating state of the power generating facility can be stored together at one location.

Alternatively, a portion of the data can be edited and/or processed on the data server. These are preferably data which are not directly associated with the automatic control function. Editing and/or partial processing of data sets on the local data server can reduce the amount of data near the location where the data are acquired. The reduced amount of data relieve subsequent processes which directly or indirectly interact with information processing and processing of the data sets. These data are used, for example, for forecasting the expected power generation of the wind power plant over a certain period of time.

It will be understood that the method for acquiring the data cannot only be applied to power plants, but also to power consumers or an energy storage facility, or to other facilities integrated with the power grid. The method for data acquisition can also apply to the purchase of power from other power grids.

To protect the local network and thereby also the entire energy generating facility from undesirable manipulation by a third party, the local network can have only a single connection to the central data server of the wide area network. In this way, only secure locations have access to the data of the data server, increasing the security for operating an energy generating facility against a potential harmful intrusion, for example by a virus. Mutual updating is provided advantageously by an automatic registration routine which is always executed when actual data sets are provided to the corresponding counterpart.

The connection between the data server of the local network and central data server of the wide area network is implemented, for example, by a fixed connection via the Internet, but other types of connections can also be utilized. For example, this can be a single data line realized by an ISDN connection. The connection can also be provided on a mobile basis, for example by a cellular network. Is also possible to provide a connection via high voltage lines. This advantageously eliminates the need for a separate connection between the data server of the local network and the central data server of the wide area network.

According to another embodiment, the data of at least one power generating facility are managed automatically on least one central data server. Preferably, all relevant energy generating facilities and/or energy consumers participating in a power grid are automatically managed. The individual power plants are coordinated automatically so that a desired power level in the power grid can always be maintained. For this purpose, the individual power generating facilities as well as the individual consumers use a standardized method to ensure that energy is reliably supplied. When the conditions in the various plants change, different routines can be automatically executed.

Preferably, the wide area network can be used to automatically coordinate information about the operating state of at least two energy generating facilities connected to the power grid and/or at least one consumer connected to the power grid. If the power grids develop a power deficit, an additional power generating facility can be automatically added to the power generating facilities already connected to the power grid, thereby immediately making up the power deficit.

It is possible that one or several energy generating facilities in a power grid do not currently achieve their full theoretical capacity. If a power deficit develops, the operating state of one or several power generating facilities is automatically changed so that the power deficit is compensated without having to add another power generating facility to the power grid.

If a power grid is fully utilized so that the individual power generating facilities cannot increase their output and no more power generating facilities can be added, an energy storage facility can be automatically switched in or power can be purchased from another power grid. At least one energy consumer can also at least temporarily reduce its power consumption, thereby compensating for the power deficit in the power grid by reducing power consumption.

Instructions for the operation of at least one energy generating facility and/or at least one energy consumer can be automatically transmitted via the wide area network for immediately initiating measures when the operating conditions of the power grid change. This ensures that in particular the power generating facilities, but also the power consumers, are always optimally utilized under changing operating conditions. Since the power of the individual power plants in a power grid is automatically coordinated, burdensome and outdated telephone instructions for operating a power generating facility can be eliminated.

According to another embodiment, information about the operating state of at least one energy generating facility and/or at least one energy consumer can be transmitted via the wide area network to an authorized person. For example, a person can request authorization from any computer, wherein authorization can be obtained via a keyboard with a numeric code or a chip card or other authorization means on a corresponding input unit. Depending on the authorization level of the person, the central server preferably transmits information to an arbitrary output unit. This information is contained in specially identified data sets, whereby only suitably identified data sets can be requested commensurate with the authorization level.

If an authorized person is an owner or a co-owner of an energy generating facility and hence receives a corresponding authorization level, he has access, for example, to information with internal data of the energy generating facility.

Conversely, a person interested in the energy generating facility obtains only general information which is limited for a wind power plant, for example, to the current power generation, the rotation speed of the rotor or the voltage as well as information about the wind conditions.

For example, the central data server includes a so-called B-2-C (business-to-consumer) platform which allows a customer or a limited partner or another user to see actual data from the respective power plant. This B-2-B platform can preferably be reached via the Internet, whereby an authorized person can read information from specially identified data sets depending on the authorization level.

Advantageously, in addition to the automatic data transmission, data storage and processing, messages can also be automatically transmitted to operators and manufacturers during service interruptions and to a service department, when maintenance and service is required. These messages can be sent to the contact partner, as specified by the operator, by telephone, fax, SMS and/or e-mail. Responses from the manufacturer and/or the service department, in particular regarding deadlines, timeframes and causes for interruptions, are then also transmitted immediately.

It is proposed to provide selected data to interested persons for free. In this context, it is useful that wind power plants can be distributed densely across a landscape. This dense data acquisition network makes it possible to capture in particular weather data, such as wind direction, wind intensity, sunshine duration and possibly data relating to precipitation or cloud cover. These data can be of interest to private and public weather institutes. Another service can relate to editing and processing of the acquired data which can then be supplied as statistical data for free to interested clients.

According to still another aspect of the present invention, a power generating plant, in particular a wind power plant, has a local area network (LAN). Even today's wind power plants do not have their own local network, which makes it significantly more difficult or even impossible to acquire diverse data. The local network can be used to coordinate several monitoring functions of the wind power plant, since the local network has several interfaces to preferably all data acquisition locations. Data acquisition locations refer to all technically meaningful installations capable of measuring a physical or chemical parameter relating to the power generating facility. The local network can also be used to perform control and/or regulating functions in addition to the monitoring functions. Information from the data acquisition locations can also be used to directly intervene in the control cycle of the energy generating facilities.

It should be noted that the aforedescribed solution of the object is not limited to power generating plants, but can also be associated with energy consumers an/or energy storage facilities.

Advantageously, the local network has at least one data server. Advantageously, the acquired data can be intermediately stored at least temporarily by integrating a data server in or with the wind power plant. This data server can be used to manage the operation of the plant. The data server can also manage and update instructions for operating the power generating plant. These instructions are obtained, for example, from the central data server, where continuously updated information for operating the power generating plant is stored. The data server can also have a fixed connection to a data server and communicate with the data server online either continuously or by establishing a connection with the central data server automatically at least when the operating conditions change. This can be implemented with an automatic registration routine which is executed, for example, when either the data server has changed data sets, or when the central data server has modified data sets which are important for the operation of the wind power plant.

Advantageously, the data server of the local network filters the data and transmits the filtered data, for example, to different central data servers depending on the information content. Filtered data can also be stored on the data server or recalled directly by an authorized person.

According to another embodiment, the local network (LAN) has to connection to at least one other network, in particular a wide area network (WAN). In this context, a local network of a local energy generator and/or a local network operator can also be viewed as another network, wherein the terms local network and wide area network should be understood to be relative. For example, another local network of another energy provider can also be viewed as a wide area network. The connection can be set up and established in different ways. For example, a data line can be established via the Internet (voice-over-data communication). Or an independent data line, for example in the form of an ISDN connection, can be used. A connection based on mobile radio technology, in particular the UMTS standard, can also be used. Likewise power lines, which do not only provide a connection between two networks or two servers, but take advantage of the power grid itself as a wide area network.

According to another embodiment, the wide area network (WAN) has at least one central data server. The central data server has preferably a connection with other central data servers, whereby all server systems should be compatible with each other, which can be achieved by a uniform or common operating software program.

The central data server manages and/or evaluates information from different data sets of the different data server sources. The data server can also offer a platform for designing an Internet page which can be automatically updated by actual data. The central data server can also acquire, process and/or transmit instructions inputted via an Internet page.

If several networks are connected together, different central data servers may be provided for different areas. These are, for example, networks from different energy providers, wherein each network has its own central data server. The central data server is connected to a super-data server which manages or administers the data sets of the individual central data servers.

Advantageously, the central data server can have a connection to different energy sources. In this way, the different energy sources can be efficiently coordinated with each other. Energy sources refer to all power plants based on renewable energy or based on conventional energy supplies, energy storage facilities as well as power derived from another power grid.

Advantageously, the data server can provide data for at least one central data server and contain the data information about the operating state of the energy generating plant. The data server can also store for later recall the data provided over a local network by the data acquisition means, which are for example sensors mounted on a wind power plant. Preferably, the data server processes at least part of the data sets so that these can be used without additional computation by an other data server, preferably a central data server.

The data server may neither store nor process special data, but provide those data only online. For example, the data sets can be from a web cam installed in or on a power generator. Persons that wish to have an overview over the operation of a plant or the location of a plant using the recorded images can directly access the data server, which then provides a corresponding data sets.

The data server can also send the updated data automatically to a central data server as well as automatically download data from a central data server, for example, in an interactive session.

All power sources and power consumers of the same type can also have a junction data server. This is a “node” which merges the data sets of the energy sources and/or the power consumer. In other words, all wind power plants can be combined in such a way that their data are combined on a junction data server for wind power plants. The same applies then also for other similar power consumers.

Accumulating several power plants is advantageous in particular when no detailed information of the individual power plants needs to be explicitly provided.

The cumulative data sets can be transmitted, for example, to a super-data server which coordinates all plants added to the power grid. Alternatively or in addition, the accumulated data sets can already be evaluated on the junction data server (even partially) and transmitted later.

Advantageously, the power generating plants and/or the power consumers can also be combined regionally in a junction data server.

It will be understood that additional technical means can be employed for transmitting or coordinating data.

It will also be understood that other power producers operating with renewable energy sources can be integrated into the standardized automatic method for power generation. These are in particular power producers which operate on the basis of hydropower plants, photovoltaic installations, biomass power plants, biogas plants, solar-thermal and geothermal power plants.

The system is designed in a modular fashion so that it can be expanded practically without limits.

In addition, consumer data can also be acquired, for example via a consumer-side interface. Such an interface can provide a connection to another power grid, the power grid of a consumer or to an end-consumer. Such consumer data can also be acquired at certain nodes simultaneously for several consumers when no detailed information about the consumption of the individual consumers is required.

According to still another aspect of the present invention in a method for load management in a power grid which includes at least two energy sources and at least one power sink, the power, which is supplied to the power grid by at least the first energy source, is automatically measured and compared with a nominal power, whereby depending of the comparison results the power supplied by a second energy source and/or a power withdrawn by an power sink are automatically coordinated. Advantageously, the load management controls and regulates all relevant power plants that are part of the power grid. For example, in the event of a malfunction or a failure of a power source, suitable measures are initiated by the load management to ensure a reliable operation of the power grid.

The term “power sink” refers hereby to any power consumer integrated in the power grid. The energy consumers withdraws from the power grid a certain power, with the nominal power of the energy grid being determined mainly by the withdrawn power. Preferably, all consumers have suitable data acquisition means. The power sources and power consumers can be connected to the power grid permanently or only temporarily.

For example, if the power consumed by one or several power sinks is so great that the instantaneous power is less than the nominal power of the power grid, then the actual power of one or several power sources is automatically adjusted. Conversely, if the instantaneous power exceeds the nominal power, then the power provided by at least one power source is reduced so as to produce a power level in the power grid which corresponds to the nominal power. Alternatively, when excess power is available, so-called energy storage facilities can be charged. If the instantaneous power becomes again less than the nominal power, then the energy stored in the energy storage facility is automatically supplied to the power grid. Alternatively, energy could be sold to another power grid. For this purpose, the load management controls and regulates the individual grids, for example the grids of regional energy providers. The load management can also control grids nationally or across Europe and/or support or augment a load management of other operators (e.g., independent power producers). The load management is also modular and therefore be easily expandable.

According to another embodiment of the method for load management, the actual state of at least one energy source can be automatically monitored. This is advantageous when several power sources supply power to a power grid. By determining the actual state of the power sources, the quantity of the supplied energy from each individual power source can be controlled so that is a nominal power is reached and/or maintained. This ensures that sufficient power is always available in a power grid and that the power sources only produce as much power as needed. Accordingly, all plants can be operated economically and ecologically.

Advantageously, for matching the power, the method for load management takes into account the power that can be produced by at least one energy source. This takes into account for the power matching not only the instantaneous effective power produced by a power source, but also the theoretically achievable maximum power at that particular time. The actual environmental conditions are very important in particular with power sources that supply power based on renewable energy sources. By constantly measuring the actual environmental conditions, the load management has available information which can indicate how much more power a particular power source can actually currently produce. The computed fictitious producible power is then taken into account by the load management for controlling the individual power sources.

Advantageously, the expected or producible power from at least one power source is forecast. This forecast makes the operation of such power grid significantly more efficient since the individual power sources can be employed more effectively. In particular, power sources which depend on the environmental conditions for providing power, require a well-organized and well coordinated grid for efficient utilization.

For example, if for operating a wind power plant, the expected wind conditions are forecast, then the method for load management can optimally use the wind power plant in the power grid at a time of expected strong wind conditions. Another example is a solar power plant, which produces full power under clear sky and unobstructed sunshine, rather than with a cloud cover. If poor weather is expected, the method for load management computes the power of the solar power plant that can be provided as a result of the environmental conditions and includes other power sources in supplying power. By managing all available power sources, including conventional power plants, in this way, an efficient power grid is created.

According to another embodiment, the load management continuously determines and automatically controls the power consumption of at least the energy sink. This provides information to the load management, which is taken into account when provisioning energy from the power sources so as to better adapt the instantaneous power level to the nominal power level. Alternatively or in addition, a power sink can also be controlled so that it withdraws more energy from the grid when excess energy is available, and withdraws less power when power is scarce. Such power sinks can be, for example, energy storage devices—also locally at an end-user, such as night storage devices, hot water boilers, washing machines (on-off), illumination stages of lighting systems, circulation pumps and the like.

These data of the power consumption of a power sink can be used to determine within certain limits a power profile of the power sink, the time of particularly high and/or particularly low power consumption.

The object of the invention is also solved with a power grid with at least one power source and at least one power sink, wherein the power source and the power sink communicate with each other interactively. This applies particularly to power sources and power sinks which either supply a certain amount of power to the power grid or withdraw a certain amount of power from the power grid. The power sources and the power sinks are technically connected in such a way that for example the power sources react automatically to a higher consumption by the power consumer without delay. If the power withdrawal from the power grid is small or becomes smaller, then the power sources are automatically instructed, for example by a central data server, to provide power to the power grid. The power of both power sources can be reduced simultaneously, or one power source can maintain or even increase its power supply level, whereas the second power source reduces the power supply level or completely disconnects from the power grid.

For example, the power consumption is particularly high at a certain point in time so that the energy sources cannot provide enough power on the basis of the renewable energy, so that energy from conventional energy sources has to be switched in. If the power consumption of the power sink is reduced in such a way that the instantaneous power is continuously greater than the nominal power, then the conventional power sources are either reduced to a lower power level or switched off entirely. The power supply by the renewable energy sources is then sufficient to maintain the power level close to the nominal power level.

The stated object is also solved by a protocol for a load management in a power grid, wherein data sets relating to the power grid are automatically supplied after at least one initialization mode to a client according to an authorization level.

The protocol is initiated by the initialization mode and executed. The initialization mode of the protocol is initiated either manually by a person-client (a natural person) or automatically by an energy-client (a power plant in a power grid). The initialization mode is used, for example, to initiate a query or a command relating to the power grid and to process a sequence of queries and/or commands.

For example, a central data server of the power grid requires actual data sets of an energy-client for guaranteeing an effective coordination of all energy-clients in the power grid. The central data server sends during initialization of the initialization mode to the energy-client automatically an identification which the central data server uses to transmit its authorization level. For example, the identification contains information about “who queries whom”, determines if a command sequence or a query sequence is present, etc. If the query relates to the currently required or consumed power and its expected duration, then the central data server receives the corresponding information automatically. The central data server initializes automatically, after processing the data, for example an initialization mode of an energy-producing client. A command sequence is executed which indicates to the power generator, for example a wind power plant, to increase the generated power. The automatically exchanged data sets of an energy-client include preferably only industrially useful information, such as power/efficiency data, information relating to the supplied power, the required power and the available power.

However, if the client is a person-client, then the initialization mode is initiated manually. The person-client is hereby instructed to input information about his authorization level and the reason for initialization. For example, the person-client can be an owner or a co-owner of a wind power plant who requests general information about the operating state of the wind power plant. The specific data sets provided to the requesting person-client depends of his authorization level and can include general information available for downloading from a web site on the Internet. The web site contains, for example, a general overview over the operating company and its energy-clients as well as medial data sets with digital images for a live check in the form of, for example, moving pictures or audio data sets. The general information can also include information about the currently supplied power, i.e., the currently supplied current and voltage. Data relating to the rotation speed of the rotor and the generator, as well as information about the wind velocity, the azimuth angle and cosines of the wind power plant can also be supplied. A person with an appropriate authorization level can also obtain links to service data and the like by using a password.

Advantageously, at least one identification is required from the client during the protocol. This identification query makes it clear which client communicates with which other client and which data sets are exchanged. For example, the energy-client is identified by installation-specific data sets which can contain information about the type of the energy-generating client. This can be, for example, a wind power plant, a hydraulic power plant, a nuclear power plant, a geothermal power plant, a photovoltaic power plant, a solar-thermal power plant, etc.

Advantageously, the data sets provided to the client can contain instructions. In this way, a client can directly receive relevant instructions of how to regulate the operation of the client. Since clients have a continuous and automatic data exchange with each other, any adaptations to actual requirements can be effective immediately.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of a wind power plant;

FIG. 2 is a schematic front view of a wind power plant;

FIG. 3 is a schematic diagram of a local network of a power generating facility;

FIG. 4 is a schematic diagram of an automatic process flow for a load management;

FIG. 5 is a schematic diagram of a manual process flow for a load management; and

FIG. 6 shows schematically a wide area network (WAN).

### DETAILED DESCRIPTION OF PREFERRED EMBODIMENTS

Throughout all the Figures, same or corresponding elements are generally indicated by same reference numerals.

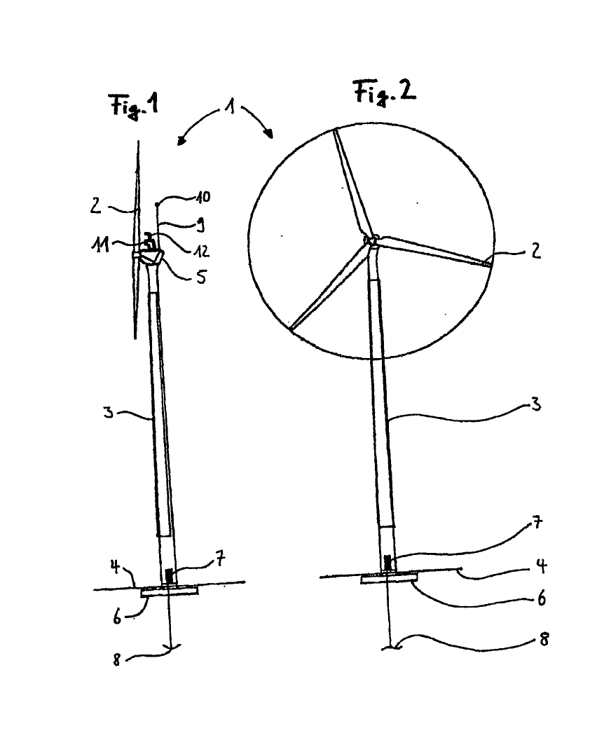

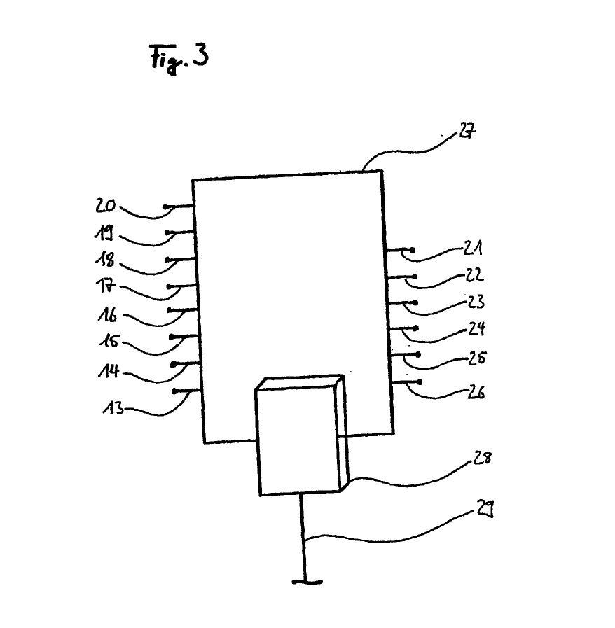

The wind power plant 1 illustrated in FIGS. 1 and 2 includes a wind wheel 2 with three blades. The wind power plant 1 further includes a mast 3 which supports the wind wheel 2 with sufficient clearance from the ground 4. The tip of the mast has a generator and a housing 5 in which the kinetic wind energy received by the wind wheel 2 is converted into electrical energy. The mast 3 is anchored in the ground 4 with the mast base 6. A data server 7 is arranged in the interior of the mast 3, wherein the data server is in communication with a wide area network (WAN) via an interface 8. The wide area network (not shown) is implemented, for example, via the power grid of an energy provider, via an Internet data link or with the help of mobile data transmission technology. The data server 7 is herein a network server of a local network. The local network connects several data acquisition locations of the wind power plant 1 with the data server 7 and transmits the actual data sets containing information about the operating state of the wind power plant 1. For data acquisition, a data acquisition unit 9 with a sensor 10 for measuring the wind velocity, a Web Cam 11 with data sets containing information of the wind power plant 1 and/or the surroundings through moving images, as well as a microphone 12 which records running noise of the wind wheel 2 of the wind power plant 1, are disposed are the generator housing 5. The local network of the wind power plant 1 further includes a plurality of such data acquisition locations allowing the determination of a large quantity of data about the operating state of the wind power plant 1.

FIG. 3 shows schematically a plurality of data acquisition locations with corresponding sensors 13 to 26 which are arranged in a local network 27 of a wind power plant 1. The local network 27 includes a data server 28 connected to a wide area network. The data server 28 stores the values determined at the data acquisition locations 13 to 26. The data acquisition location 13 is capable of determining the actual rotation speed of the wind wheel 2. The data acquisition location 14 supplies corresponding values of the rotation speed of the generator of the wind power plant 1. The sensor of the data acquisition location 15 determines the instantaneous power which is supplied by the generator arranged in the generator housing 5 due to the actual wind conditions. The data acquisition location 16 supplies the corresponding values of the wind intensity. The data acquisition locations 17 and 18, on the other hand, determine values for transmitting medial events of the wind power plant 1, such as moving images and/or the actual running noise of the wind wheel 2. The medial data can be compared with an optimal reference profile to indicate possibilities for optimization; alternatively, they may only provide visual or acoustic data. The local network 27 of the wind power plant 1 includes additional data acquisition locations 19 to 22 which provide additional information about the actual power/efficiency conditions by indicating the instantaneous values of the generated current and voltage, the phase shift and the azimuth angle. The local network 27 has additional data acquisition locations 23 to 26 that measure additional general data of the environmental conditions of the wind power plant 1, for example, solar intensity, precipitation, barometric pressure and relative humidity. The data server 28 of the local network 27 stores the actual values and partially processes data sets, wherein the processed information is transmitted to a central data server arranged in the wide area data network.

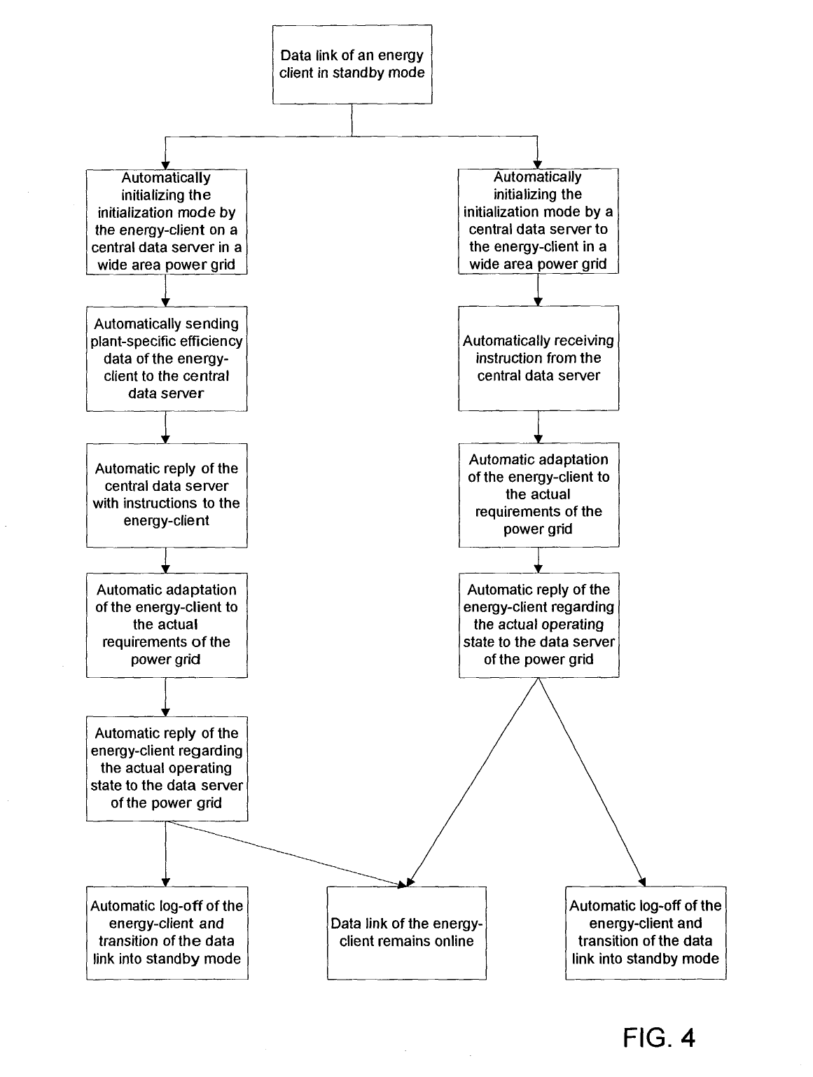

FIG. 4 shows an exemplary flow diagram of the protocol for a load management. The illustrated flow chart starts with an energy-client having a data link to a wide area network (WAN) that is in standby mode.

The left half of flow chart shows an automatic initialization of an initialization mode by the energy-client to a central data server in a wide area power grid. This situation arises when the instantaneous operating state of the energy-client changes so as to have a relevant difference from the previous operating state. This causes the initialization mode to be automatically initialized. When the initialization mode is executed, identification parameters are automatically exchanged between the communicating energy-client and the selected central data server. The identification parameters are provided to unambiguously identify of the energy-client and provide important information about the actual operation of the energy-client. The plant-specific efficiency data are automatically transmitted to the central data server during and/or after the initialization mode. The energy-client also receives automatically a reply from the central data server with current instructions for the continued operation of the energy-client, whereby the data server energy-clients receives a comprehensive update. After the data sets between the energy-client and the data server have been exchanged in both directions, the energy-client begins to automatically adjust the operating state, thereby directly reacting to the actual requirements of the power grid. After the energy-client has adapted to the new operating conditions, it automatically provides a reply to the central data server of the power grid, so that the actual data of the energy-client are now provided to the central data server. When all important data are exchanged, the energy-client automatically logs off from the wide area network, the power grid, and the data link of the energy-client goes back into the standby mode, or the data line of the energy-client remains online.

The right side of the flow chart shows the situation with a central data server which is located in a wide area power grid and logs on to an energy-client by automatically initiating an initialization mode. The initialization mode is initialized similar to the automatic initialization described in the discussion above of the left side of the flow chart. This time, however, the process is initiated by the central data server which establishes the connection between the central data server and the energy-client. The energy-client receives automatically instructions for the central data server. The instructions include information used to adapt the energy-client to the current requirements of the power grid. When the energy-client has adapted according to the actual instructions, the energy-client automatically sends a corresponding reply to the central data server of the power grid. After a successful information exchange between the energy-client and the central data server, the data link of the energy-client to the central data server remains either online in the power grid, or the energy-client logs off automatically from the central data server and the data line goes into the standby mode.

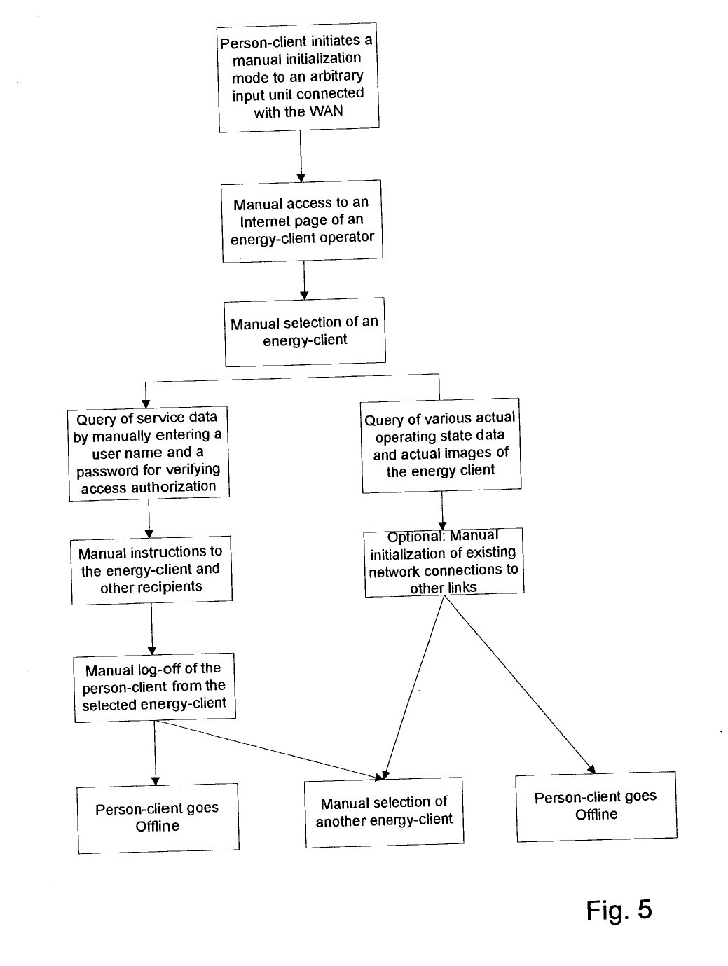

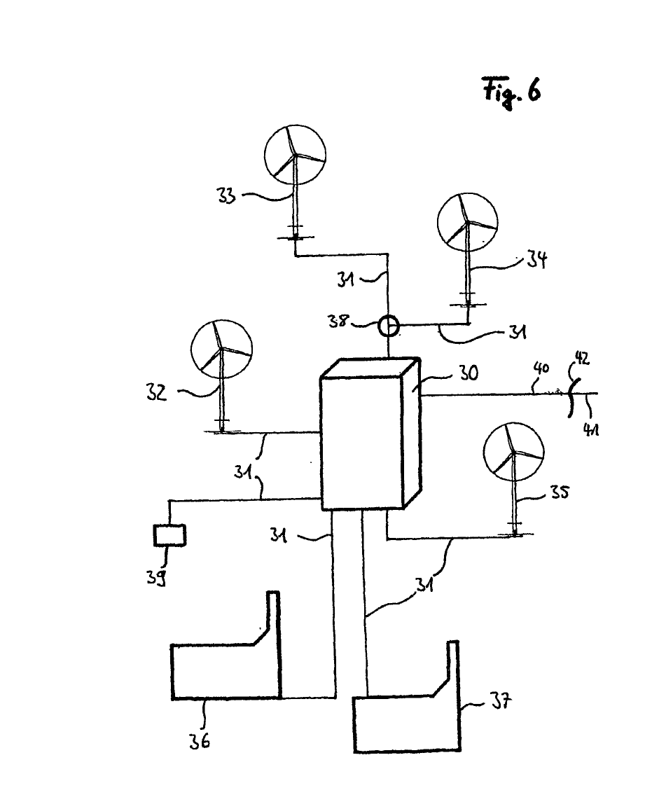

FIG. 5 shows a flow chart giving a general overview about the process flow of a manual initialization mode. A person-client initiates the initialization mode manually with an arbitrary input unit connected to the wide area network. The person-client who is an owner or a co-owner of an energy-client or merely a person interested in an energy-client, accesses manually by computer input an Internet page of the respective energy-client operator. The Internet page allows the person-client to select manually any energy-client connected to the power grid. Thereafter, a person-client with a low authorization level only obtains information about various general actual operating conditions of the energy-client as well as actual images and/or other medial impressions of the energy-client. Additional existing network links can be selected manually via an input unit. When the person-client has received the desired information about the selected energy-client, he can either go off-line or select manually an additional energy-client.

If the person-client has a correspondingly high authorization level, he can request more comprehensive data, such as special service data, by manually inputting the username and a password for verifying the access authorization. Manual instructions can also be sent to the energy-client within the authorization level. Depending on the authorization level of the person-client, manual instructions can be given to other recipients. After all desired actions have been completed, the person-client manually logs off from the selected energy-client via the input unit. Thereafter, an additional energy-client 32 to 37, 39, 41 can be selected manually. Alternatively, if this is neither required nor desirable, the person-client goes off-line.

FIG. 6 shows a central data server 30 which is connected via a wide area network 31 with different energy-clients. The wide area network 31 has four energy generating plants 32, 33, 34 and 35, two energy consumers 36 and 37, an energy storage facility 39, as well as another power grid 41. The power grid 41 is connected via a link 40 and an interface 42 with the wide area network 31. The power generating plants 33 and 34 come together in a node 38. The node 38 is a junction server which accumulates the relevant power data of the power generating plants 33 and 34. The junction server can process the data sets transmitted to the junction server, thereby significantly reducing the amount of data to be transmitted to the central data server. This is advantageous if not all data of the energy-client have to be separately acquired to ensure an efficient operation. Preferably, the junction server stores data sets of energy-clients of the same type. It is also advantageous to combine energy-client from a certain region or geographic area.

The data server 30 processes the data transmitted from the individual energy-clients and manages and coordinates the results from the individual energy-clients accordingly.

This coordination helps balance the power generation and the power consumption. However, if an excess of power exists in the grid 31, then the power is supplied to the energy storage facility 39. Alternatively or in addition, excess power can also be supplied to an additional power grid 41. If the power generators 32 to 35 are unable to maintain a certain nominal power level in the power grid 31, then the energy stored in the energy storage facility 39 it is again supplied to the power grid 31. It is also possible to buy power from the power grid 41. If the power level of the power grid cannot be maintained, either by generating power in the power plants 32 to 35 or by switching in the energy storage facility 39 or by buying energy from an additional power grid 41, then the data server reduces the power consumption of the individual power consumers 36 and 37 so that the available power is optimally distributed among all relevant power consumers. The wide area network can be optimally utilized by intelligently controlling the various energy-clients.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for producing power with at least two decentralized power converters connected with a global power network, comprising the steps of:
determining power-generator-specific parameters of at least one of the power converters;
transmitting the determined power-converter-specific parameters to the global data network via a standardized interface, said standardized interface merging the determined power-converter-specific parameters;
processing the merged power-converter-specific parameters with a central data server provided in the global data network into an actual command for at least one of the power converters;
transmitting the actual command via the standardized interface from the global data network to the at least one power converter; and
adjusting operating parameters of the at least one power converter based on the actual command.

2. A device for producing power, comprising
at least two power converters connected with a global power grid, and
at least one standardized interface connecting at least one of the power converters with a global data network.

3. The device of claim 2, wherein the global data network includes a central data server

4. The device of claim 2, wherein at least one of the power converters is a power generator, the device further comprising means for forecasting the power to be produced by the at least one power generator, said means selected from the group consisting of wind measuring devices, weather stations, and exposure meters.

5. The device of claim 2, and further comprising a data receiving station and means for automatically integrating the data receiving station into one of the global power grind and the global data network.

6. The device of claim 2, and further comprising an output unit for outputting information about the state of at least a power converter and the power grid, said output unit including means for checking an authorization of a reader of the output unit for receiving the information.

7. An interface of a global data network, comprising:
connections to at least two power converters connected with a global power grid; and
means for standardizing power-converter-specific parameters of the at least two power converters.

8. A profile of an interface, wherein the profile standardizes parameters specific to at least one of power-converter-specific parameters and power grid specific parameters.

9. The profile of claim 8, wherein the profile filters the power-converter-specific parameters into business-specific data and multimedia-specific data and provides the data to different clients.

10. A power generator, comprising an automatically readable interface to a global or national network for indicating an actual power output of the power generator.

11. The power generator of claim 10, wherein the automatically readable interface further comprises an output unit that outputs a power that can be produced by the power generator.

12. The power generator of claim 11, wherein the output unit indicates information about an actual state of the power generator.

13. The power generator of claim 11, further comprising an input unit for an automatic control of the power.

14. The power generator of claim 11, wherein the output unit provides information indicating a state of the power generator, said output unit including means for checking an authorization of a reader for reading the information provided by the output unit.

15. A method for acquiring data of power generating plants, in particular wind power plants, wherein the acquired data are automatically transmitted from the power generating plants to at least one data server via a local network (LAN).

16. The method of claim 15, wherein the data server is connected to a wide area network (WAN) and transmits information automatically to the at least one central data server via the WAN.

17. The method of 16, wherein the at least one central data server automatically manage the data of at least one of the power producing plants.

18. The method of claim 16, wherein at least one of the power generating plants and a consumer is connected to a power grid, and wherein the at least one central data server standardizes information about an operating state of the at least one power generating plant and the consumer.

19. The method of claim 16, wherein the information transmitted via the WAN includes instructions for the operation of at least one the power generating plants or at least one power consumer.

20. The method of claim 16, wherein the information transmitted via the WAN includes information about an operating state of at least one power generating plant or at least one power consumer, said information being transmitted to an authorized person.

21. The method of claim 20, wherein said information includes selected data that are provided to interested persons for free.

22. A power generating plant, in particular a wind power plant, comprising a connection to at least one wide area network (WAN).

23. The power generating plant of claim 22, wherein the wide area network (WAN) has a connection to at least one local area network (LAN).

24. The power generating plant of claim 23, wherein the local network (LAN) comprises at least one data server.

25. The power generating plant of claim 22, wherein the wide area network (WAN) comprises at least one central data server.

26. The power generating plant of claim 24, wherein the wide area network (WAN) comprises at least one central data server and the data server stores data for the at least one central data server, said stored data including information about an operating state of the power generating plant.

27. A method for load management in a power grid, which includes at least two power sources and at least one power drain, comprising the steps of:
measuring a power supplied to the power grid by at least a first power source and comparing the supplied power with a nominal power, and
automatically adapting at least one of power supplied by a second power source and power consumed by a power drain,
wherein said adapting is performed depending on a result of the comparison.

28. The method of claim 27, and further comprising the step of monitoring an actual state of at least one power source.

29. The method of claim 27, wherein said adapting step includes the step of taking into account a power level that is expected to be supplied by the at least one power source.

30. The method of claim 29, wherein the expected power of the at least one power source is forecast.

31. The method of claim 27, and further comprising the step of controlling the power consumption the power drain.

32. A power grid with at least two power sources and at least one power drain, wherein at least one of the two power sources and the at least one power drain communicate with each other interactively.

33. A protocol for a load management in at least one power grid, said protocol including protocol instructions for initializing at least one initialization mode, and automatically providing to a client data sets for the power grid according to an authorization level of the client.

34. The protocol of claim 33, and further including protocol instructions for sending at least one station identification request to the client.

35. The protocol of claim 34, wherein data sets are provided to the client, said data sets including operating instructions.
